(19) United States
(12) Patent Application Publication
(10) Pub. No.: US 2011/0048875 A1
(43) Pub. Date: Mar. 3, 2011

(54) BRAKE EQUIPMENT SYSTEM OF ROLLING STOCK

(76) Inventor: Anton Murtazin, Ekaterinburg (RU)

(21) Appl. No.: 12/672,519

(22) PCT Filed: Dec. 13, 2007
(86) PCT No.: PCT/IB07/55072

§ 371 Date: Feb. 8, 2010

(30) Foreign Application Priority Data
Aug. 8, 2007 (RU) 2007130442

(51) Int. Cl. B60T 13/24; F16D 65/32; F16D 65/40

(52) U.S. Cl. 188/153 R

(57) ABSTRACT

The invention relates to railway vehicles, namely to the brake equipment of truck of the car. The system of the brake equipment on each truck contains an air control valve, an auxiliary reservoir (4), an empty/load valve (3) and brake cylinders (12). The cylinders (12) exert a force directly on cross arms (10) with the brake shoes (9). The improved mounting of pneumatic brake devices on truck at preservation of demanded dimensions is offered. It provides independent transfer of brake efforts to the executive mechanism of each truck according to conditions of its operation. Increase of efficiency of braking of vehicles, reception of stable brake characteristics and operational reliability is reached.

### FIELD OF THE INVENTION

The invention relates to the rail transport and is intended for optimization of positioning of the pneumatic devices of the brake equipment of the rolling stock.

### BACKGROUND AND SUMMARY OF THE INVENTION

With a technological expansion demand much of a control efficiency by pneumatic braking systems of a rolling stock. The specified systems comprise the equipment, established as at the car (“car mounted”), just as, mounted on its trucks (“truck mounted”). Usually on trucks, for example, type Barber, NACO, ASF, 18-100 and others, are established operating members of the brake equipment in the form of a mechanical part.

It comprises a lever motion, effecting on brake shoes, tightly pressed to wheels under braking Its efficiency is defined by quantity of levers, which transfer efforts said shoes. As often as not the big losses there are just here. The lever motion efficiency in operation fluctuates from 0.6 to 0.9, i.e. losses can be in limits from 10 to 40%.

Devices of a pneumatic part of a vehicle composed of an air control valve (air distributor), the auxiliary reservoir, an automatic regulator of modes of braking depending on loading (load-dependent brake valve=empty/load valve) and a brake cylinder operate on a said mechanical part. The arrangement concerning the car and elements of its truck of an air distributor (air control valve) and a brake cylinder rigidly is not set and consequently under development of such systems were varied. In view of the implied principle of operation the empty/load valve may be installed only in-between of the spring-borne and non-sprung parts of the truck.

At operation of braking systems can be observed the status when force of pressing of shoes on both trucks can be established unequal for all wheelpairs of the truck because of presence of elements of a lever motion (a brake cylinder is established in front of the truck) and-or under non-uniform loading of the car. It will affect on braking efficiency of a rolling stock, and also will lead to an asymmetrical status of the cars in the maintenance and as a whole to kickdown of reliability of system.

There is in also time a truck design, intended for use in the train out of trailers. It contains in a braking system of the truck the auxiliary reservoir, an air control valve, a brake cylinder and the device sensitive to loading (so-called “truck mounted”). The train of trailers is formed at joint in a uniform brake highway of such trucks. Imperfection of such system consists in presence on trucks of a lever motion, not optimum installation on a beam of the truck of an air distributor with the reservoir and the device sensitive to loading (analogue of an empty/load valve).

That is, at installation of said trucks on freight cars a creation of different brake forces for trucks of opposite parts of the car depending on conditions of their operation increasingly is provided. However, the optimum arrangement of brake devices is necessary, for example, to increase of speed of operation at the expense of reduction of length of pipe ducts between an empty/load valve and an air control valve. Besides, in connection with above named reasons, it is desirable that the length of a lever motion has been reduced. Accordingly, there is a requirement in the prolongation an job on improvement of braking systems and by that to improve the means of transportation.

According to the present invention there is provided a brake equipment system of the rolling stock comprising a air distributor, an auxiliary reservoir, a load-dependent brake valve and at least one brake cylinder which ensures transmission of the brake efforts onto the actuating unit of the truck, in the process all said are connected by the air pipes characterized in that the system is equipped with an additional auxiliary reservoir in such a manner that one (two) reservoir(s) are located in the body of the truck bolster, pair of the two (three)-pistons or double cylinders, which synchronously are acting upon the brake shoes of the wheelsets via cross arms and are located under the respective grooves in the truck bolster with each side on the side frame hangers so that limiting overall dimensions of the truck in a loaded condition were not exceeded, in doing this, the air distributor with load-dependent brake valve, which are secured on the truck bolster, as well as the brake cylinders and auxiliary reservoirs located on the trucks ensure independent transmission of the brake effort from the brake shoes to the wheels of each truck in keeping with its operation conditions.

Furthermore, according to the invention, said the cross arm being located most near to an load-dependent brake valve for indemnification of change of its vertical position in connection with a change of the brake shoe position on a wheel because of its deterioration and possible deviations of wheels on diameter has an inclined platform with raised up distant from truck bolster the edge at which the rotary lever of an the load-dependent brake valve of the truck rests.

Preferably, according to the proposed approach two double brake cylinders are multi-piston devices and the air distributor has a built-in automatic control function (united with the load-dependent brake valve).

In connection with stated above the invention has for its object to provide increase of efficiency of braking of a railway rolling stock with use of the brake system mechanisms located on each truck, optimisation of an arrangement pneumatic and mechanical components of brake system on the truck consisting, at least, from two wheel pairs, connected by lateral frames and truck bolster. The progress in the art of the proposed technical decision consist in, enhancement of the efficiency of the brake system of the rolling stock and improvement of positioning of the pneumatic devices for independent braking by devices of each truck.

The possibility for reaching the beneficial action when using the proposed technical decision may be afforded e.g. thus. The mounting on the truck above-listed of the brake equipment allows to relieve the carriage body from the auxiliary functions. Integration of additional pneumatic devices permits to create two subsystems which independently, i.e. in the off-line mode, are operated a trucks actuators of the transport facility depending on the operation conditions. Two subsystems are powered by the common brake line. Such an braking control allows to use the brake effort of each truck of the rolling stock most efficiently. The sloping platform simply are fixed on the cross arm connected with the side frames. Her incline serves to compensate the possible wear of the wheel and brake shoes in the course of operation. Combining of the functions of the load-dependent brake valve and air distributor in one unit simplifies the design and reduces labor input of installation and operation. The distinctive properties of the present invention, which are considered new, are stated in the enclosed items of the claim of invention.

### BRIEF DESCRIPTION OF THE DRAWINGS

The invention will be more clear out of consideration resulted below. The description referring to applied drawings on which identical positions designate identical elements:

FIG. 1 shows general view of the brake equipment system for the truck braking of the railway rolling, stock with use of the brake system mechanisms located on each truck;

FIG. 2 shows the front view of the brake system on the truck;

FIG. 3 shows the side view of the side frame with the brake cylinder arrangement.

### DETAILED DESCRIPTION OF PREFERRED AND VARIOUS ALTERNATIVE EMBODIMENTS OF THE INVENTION

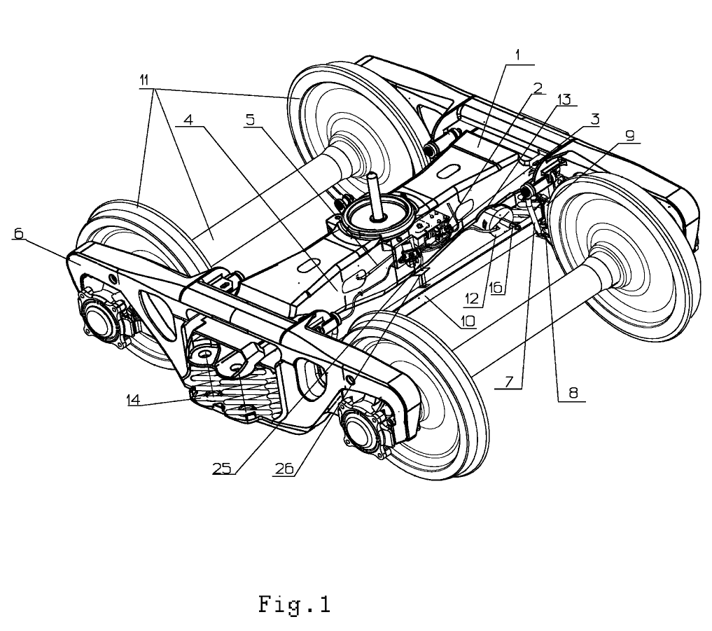

The pneumatic system of the brake equipment is secured on the truck of the railway carriage and comprises mounted on truck bolster 1 air distributor 2, load-dependent brake valve 3, auxiliary reservoir 4, which can be divided into two capacities or to be as one capacity. Said reservoir are located in the body of truck bolster 1 in the areas with the increased rigidity. Air piping 5 connects the above brake tools in accordance with their of the layout drawing. There are brake blocks 8 with brake shoes 9 at the holder end 7, which hangs on the projection of side frame 6. The opposite brake blocks (9) of wheelset 11 is located on the cross arm 10. Brake cylinders 12 are located between a cross arms 10 under respective grooves 13 in the truck bolster 1 alongside with a side frame spring cartridge 14 (FIG. 1).

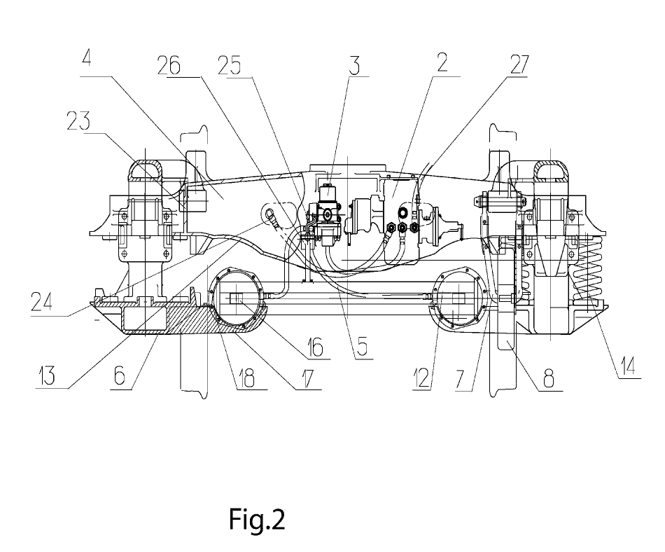

To cross arms a corresponding fastener 15 of the cylinder body (it is shown on φκr.3) and an exit of a rod 16 brake cylinder make fast. The second brake cylinder is positioned symmetrically (FIG. 1). FIG. 2 shows a slightly different fastening of the brake cylinder. Here side frame 6 has a projecting lobes 17 of the respective form for fastening the brake cylinder, for example, by clamp 18. In this case the brake cylinder is a double unit i.e. the cylinder rods acting on the cross arms into different directions are moving.

As a break cylinder spring is enabled for release of the brake shoes, the spring-loaded rod does not allow the cross arms with brake shoes on holders to vibrate. In the former case to cut out oscillations in the course of movement an holders with the elastic bushings may be used. They will quench oscillations of the supported elements in motion. It is important that in case of all tiltings and turnings of the car the contact of the truck bolster of the brake cylinder was ruled out i.e. was ensured sufficient clearance under maximum loading.

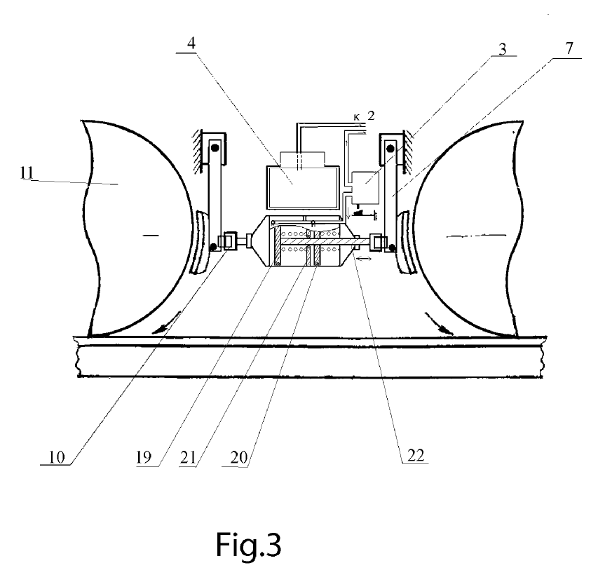

This requirement may be satisfied through the use of the multi-piston cylinder as well. Maintaining the required efforts on the rod with the prescribed pressure one may arrive at smaller values of the brake cylinder diameter. The quantity of pistons of the cylinder is preset by distances between wheel steams and a necessary course of a rod. Respectively, the double cylinders may also have more than one piston. Side view FIG. 3 gives the cylinder with two pistons 19 and 20, partitioned 21, through which rod 22, common with second piston, is passing. The latter may have the braking effort self-compensator. Such technical decisions are known in this specified pertinent art. It is clear that, flexible air ducts shall be used for connection to the load-dependent brake valve of the operating chambers of the brake cylinders fixed to the stationary part of the truck.

Connection of the air distributor and auxiliary reservoir located in the body of the truck bolster may be executed in the conventional manner. Reservoir cavities can arc formed by direct casting of additional solid partitions 22 (FIG. 2) as well as by welding or in a different way of the technologic apertures after the respective cleaning of founding. The connecting pipe 23 meanwhile is used for connecting to air distributor 2. The beam stiffness may be preserved due to application of additional stiffening ribs or areas with increased stiffness. Flexible reservoirs which conform to the requirements of the specifications of operation conditions for the said transport facility may be used for this purpose as well.

Load-dependent brake valve 3 is intended for independent control of the pressure forces of the brake shoes of the wheelsets of the truck through controlling pressure of the compressed air fed to brake cylinders 12, which in its turn depends on the operation conditions of the truck wheelsets. Load-dependent brake valve 3 is secured on the projections of the truck bolster (see FIG. 1) beside the air distributor and interacts with the non-sprung truck part of the truck by means of the swiveling arm support 24 onto the surface of sloping platform 25 secured on the cross arm. The inclination angle of sloping platform 25 is selected in such a way in order to allow for possible wear of the brake shoes and wheels. In the current case the most distant from the truck bolster edge of the sloping area is elevated relative to the nearest edge.

Air distributor 2, auxiliary reservoir 2, brake cylinders 12 and load-dependent brake valve 3 form a pneumatic subsystem for braking of the truck of the car. The proposed positioning of the air distributor with the load-dependent brake valve allows to enclose of them in one and the same casing and impart to the air distributor the functions of the load-dependent brake valve. Here the key condition for installation of the air distributor is nearness of its main fitting to the brake pipe. So it is preferable to locate the fixturing point of this device nearer to the side frame.

This will helpful when a pneumatic device is replaced. The air distributor is connected to the brake pipe (not shown) via the air duct 26 finning from air distributor 2 via the respective disconnecting cock and tee fitting (not shown). The disconnecting cock may be mounted directly on the air distributor. The other truck has similar pneumatic devices, at the same time an air distributor fitting for connection to the brake pipe is also located as possible near to it. The proposed pneumatics of the brake equipment with the Independent braking by each truck is mounted, for example, on the freight car and can be operated in the following way.

In case of braking service or emergency brake application, incipient after reduction of pressure in the brake pipe, air distributor 2 open up possibility of obtaining of air from the auxiliary reservoir 4 through air intake pipes 5 to load-dependent brake valve 3 of the truck, thereupon a compressed air through pipes is entering to brake cylinders 12. Each load-dependent brake valve allows to supply compressed air to brake cylinders with pressure corresponding to position of the lever perceiving loading.

It adjusts independent pressing effort of the brake shoes onto the truck wheels depending on the slump value of the spring in proportion to the freight weight and other operation conditions of each truck. The brake cylinders rods under the action of the compressed air pressure transmit the respective brake forces to the truck wheelsets via the actuating device-made in the form of cross arm 10 and holder element 7 of the brake shoe. As the brake cylinder rod acts upon the brake shoes with the minimum number of transmission units, thereby in actual fact the requisite maximum possible efficient coefficient of the brake equipment can be reached.

Use of the cylinder with two or three pistons allows to reduce the diameter of the body and to change minimally the design of the truck bolster. Combining of several functions in one unit provides for more close together positioning of the pneumatic devices on the truck. Thus, application of the proposed technical decision allows to increase efficiency of the railroad braking system under the braking of the every truck through optimization of positioning the brake devices of the railway car. Together with this, in case of repair an entire truck with the braking devices may be exchanged with other. This brings about reduction of the delay time of the rolling stock, which is a rather vital issue.

In terms of the proposed technical decision the required design documentation for manufacture of the pilot samples of the trucks and their testing in the real-life environment has been prepared. At the same time some of the shortcomings, which showed up at realization of technical decisions of the application RUN°20Q6106002 preferred previously, here have been eliminated. As a matter of fact, offered therein the decisions (how an accessory materials), have formed a basis for these and subsequent offers in the given area. In doing this, as the load-dependent brake valve, the pneumatic device AR_{/}I6 and widely used air distributor 483 type were installed. It is evident that, models of these devices may differ from the devices which we used (e.g. EP-60 and EL-60).

The proposed technical decisions are not limited to the above description which serves as an example as a possibility and modifications within the proposed invention both set forth earlier and specified in the claims of invention are possible.

What is claimed:

1. The brake equipment system of the rolling stock with the pneumatics devices on each truck comprising: a) an air distributor, b) an auxiliary reservoir, c) a load-dependent brake valve and d) at least one brake cylinder, which provides for transmission by means of linkage of the brake effort onto the truck actuating mechanism, meanwhile said devices are connected by the air pipes, characterized in that said system contains auxiliary reservoir in such a way that one (two) reservoir (s) are located in the body of truck bolster, two two- (three-)piston or double brake cylinders, synchronously acting upon the brake shoes of the wheelsets through the cross arms and located under the respective groove in the truck bolster on each side on the holders of the side frames so that the overall dimensions limits in the loaded truck state are not surpassed, meanwhile, the air distributor and load-dependent brake valve fixed on the truck bolster, also the brake cylinders and auxiliary reservoirs located on the trucks ensure the independent transmission of brake forces via the cross arms of actuating mechanism onto the wheels brake shoes of each truck in accordance with its operation conditions.

2. The system according to claim 1, characterized in that at said cross arm located on the side of the load-dependent brake valve have the sloping platform with a to top raised edge distant from the truck bolster, on which the lever of the load-dependent brake valve is put to compensate for the change in its vertical position in connection with the change of the position of the brake shoe on the wheel due to its wear and possible deviation of the wheel diameter.

3. The system according to claim 1, characterized in that two double brake cylinders are multi-piston cylinders and the air distributor has a built-in load-dependent brake valve.
